(19) United States
(12) Patent Application Publication
(10) Pub. No.: US 2002/0146350 A1
(43) Pub. Date: Oct. 10, 2002

(54) Real time monitoring system

(76) Inventors: Jiunn-Guang Lo, Hsinchu (TW); Shun-Hsiang Ke, Chiai (TW)

Correspondence Address: Mathews, Collins, Shepherd & Gould, P.A., Suite 306, 100 Thanet Circle, Princeton, NJ, 08540-3674, US

(21) Appl. No.: 09/888,354

(22) Filed: Jun. 22, 2001

(30) Foreign Application Priority Data
Feb. 2, 2001 (TW) 090102432

(51) Int. Cl. G01N 30/02

(52) U.S. Cl. 422/89; 422/83; 436/161; 436/154; 436/173

(57) ABSTRACT

A real time monitoring system for automatically monitoring a gaseous pollution sample in environment. The system includes a sample preprocess apparatus (SPA) for immediately processing the gaseous pollution sample at room temperature, wherein the gaseous pollution sample includes a polar and a non-polar compounds, a sample separation apparatus for separating the gaseous pollution sample, a sample analysis apparatus for analyzing a target compound of the gaseous pollution sample, and a data processing device for automatically processing an analyzed data of the target compound to achieve the real time monitoring system.

### FIELD OF THE INVENTION

The present invention relates to a real time monitoring system, and more particularly to an on-site real time monitoring system applied to monitor a gaseous pollution sample varying with time and wind direction in environment.

### BACKGROUND OF THE INVENTION

Along with the development of high technology industry, the chemical material used in the semiconductor and photoelectric industries becomes an issue for the environmental pollution. The chemical material, including hazardous gas, acid, alkali, and organic solvent, has latent chemical hazard. The organic solvent including dichloromethane, isopropyl alcohol (IPA), toluene, trichloroethylene and acetone will be dissipated to ambient air via the exhaust system, and further results in the environmental pollution.

Generally, for monitoring the organic solvent in operation environment of the high technology industry, it is necessary to collect the hazardous organic sample on-site and then bring back to the laboratory to proceed the typical gas analysis. Hence, a long time is required to know the amount and property of the hazard organic sample. Therefore, when an emergency event is happened, the hazardous organic sample cannot be monitored on time and on spot in the prior art, which does not have the immediate detecting and warning effects.

Therefore, the purpose of the present invention is to develop a real time monitoring system to deal with the above situations encountered in the prior art.

### SUMMARY OF THE INVENTION

It is therefore an object of the present invention to propose a real time monitoring system for automatically sampling, separating, analyzing and processing data to reduce labor- and time-consumptions.

It is therefore another object of the present invention to propose a real time monitoring system for monitoring the environmental air quality with high flexibility and high efficiency.

It is therefore an additional object of the present invention to propose a real time monitoring system for reducing the consumption of cooling agent.

It is therefore an additional object of the present invention to propose a real time monitoring system for handling and monitoring by remote control.

According to the present invention, there is proposed a real time monitoring system for automatically monitoring a gaseous pollution sample in environment. The system includes a sample preprocess apparatus (SPA) for immediately processing the gaseous pollution sample at room temperature, wherein the gaseous pollution sample includes a polar and a non-polar compounds, a sample separation apparatus for separating the gaseous pollution sample, a sample analysis apparatus for analyzing a target compound of the gaseous pollution sample, and a data processing device for automatically processing an analyzed data of the target compound to achieve the real time monitoring system.

Preferably, the system further is connected to a remote transmission system for immediately transmitting the analyzed data to a user, wherein the remote transmission system including a remote controlling system and a warning system.

Preferably, the system further includes a systemically automatic adjusting device employing a standard sample inside a capillary column to adjust the analysis apparatus for maintaining the stability of the real time monitoring system. The systemically automatic adjusting device preferably includes a pneumatic valve used for injecting the standard sample inside the capillary column into the sample preprocessing apparatus for adjusting the real time monitoring system. The pneumatic valve is a four-way pneumatic valve.

Certainly, the real time monitoring system can be a real time on-site monitoring system.

Preferably, the system sample preprocessing apparatus includes an entering position directly connected to ambient for adsorbing the gaseous pollution sample, a pump connected to the entering position for providing a sucking power, a mass flow controller for controlling a flow rate of the gaseous pollution sample, an exiting position for outputting the gaseous pollution sample, and a sample preconcentration device (SPT) for concentrating the gaseous pollution sample. Preferably, the sample preconcentration device employs an adsorbent for adsorbing the target compound and further employs a cooling agent for enhancing the adsorption of the target compound. Preferably, the cooling agent is liquid carbon dioxide.

Preferably, the separation apparatus includes a capillary column for separating the gaseous pollution sample, a column oven for providing temperature changing, and a carrying gas for carrying the gaseous pollution sample. Preferably, the carrying gas is Helium.

Preferably, the sample analysis apparatus employs a gas chromatograph and a detector for proceeding qualitative and quantitative analysis. Certainly, the detector can be a flame ionized detector (FID), an electronic capture detector, or a mass spectrophotometer.

Preferably, the target compound is acetone, 2-butanone, isopropyl alcohol (IPA), benzene, trichloroethylene, 2-butanol, toluene, butyl acetate, m,p-xylene, o-xylene, cyclopentanone, propylene glycol monomethylethyl acetate (PGMEA) or the mixture thereof.

According to the present invention, there is proposed a real time monitoring system for automatically monitoring a gaseous pollution sample in environment. The system includes a sample preprocess apparatus (SPA) for immediately processing the gaseous pollution sample at room temperature, the sample preprocess apparatus comprising a systemically automatic adjusting device for adjusting and stabilizing the real time monitoring system, wherein the gaseous pollution sample including a polar and a non-polar compounds, a sample separation apparatus for separating the gaseous pollution sample, a sample analysis apparatus for analyzing a target compound of the gaseous pollution sample, and a data processing device for automatically processing an analyzed data of the target compound to achieve the real time monitoring system.

According to the present invention, there is proposed a real time monitoring system for automatically monitoring a gaseous pollution sample in environment. The system includes a sample preprocess apparatus (SPA) for immediately processing the gaseous pollution sample at room temperature, the sample preprocess apparatus comprising a sample preconcentration device for immediately concentrating the gaseous pollution sample, wherein the gaseous pollution sample comprises a polar and a non-polar compounds, a sample separation apparatus for separating the gaseous pollution sample, a sample analysis apparatus for analyzing a target compound of the gaseous pollution sample, and a data processing device for automatically processing an analyzed data of the target compound to achieve the real time monitoring system.

The present invention may best be understood through the following description with reference to the accompanying drawings, in which:

### BRIEF DESCRIPTION OF THE DRAWINGS

FIG. 1 is a diagram illustrating a real time monitoring system, a transmission system and a warning system for monitoring a gaseous pollution sample in environment according to the present invention;

FIG. 2 is a diagram illustrating a real time monitoring system according to a preferred embodiment of the present invention;

FIG. 3 is a chromatogram illustrating a standard peak of a target compound according to the present invention;

FIG. 4 is a chromatogram illustrating a blank of a target compound according to the present invention;

FIG. 5 is a plot illustrating a real time monitoring system to monitor acetone along with time according to the present invention;

FIG. 6 is a plot illustrating a real time monitoring system to monitor benzene along with time according to the present invention;

FIG. 7 is a plot illustrating a real time monitoring system to monitor cyclopentanone along with time according to the present invention;

FIG. 8 is a plot illustrating a real time monitoring system to monitor o-xylene along with time according to the present invention;

FIG. 9 is a plot illustrating a real time monitoring system to monitor IPA along with time according to the present invention;

FIG. 10 is a plot illustrating a real time monitoring system to monitor m,p-xylene along with time according to the present invention;

FIG. 11 is a plot illustrating a real time monitoring system to monitor toluene along with time according to the present invention;

FIG. 12 is a plot illustrating a real time monitoring system to monitor propylene glycol monomethylethyl acetate (PGMEA) along with time according to the present invention;

FIG. 13 is a diagram illustrating a real time monitoring system to monitor acetone along with time and wind direction according to the present invention;

FIG. 14 is a diagram illustrating a real time monitoring system to monitor cyclopentanone along with time and wind direction according to the present invention;

FIG. 15 is a diagram illustrating a real time monitoring system to monitor o-xylene along with time and wind direction according to the present invention; and

FIG. 16 is a diagram illustrating a real time monitoring system to monitor propylene glycol monomethylethyl acetate (PGMEA) along with time and wind direction according to the present invention.

### DETAILED DESCRIPTION OF THE PREFERRED EMBODIMENTS

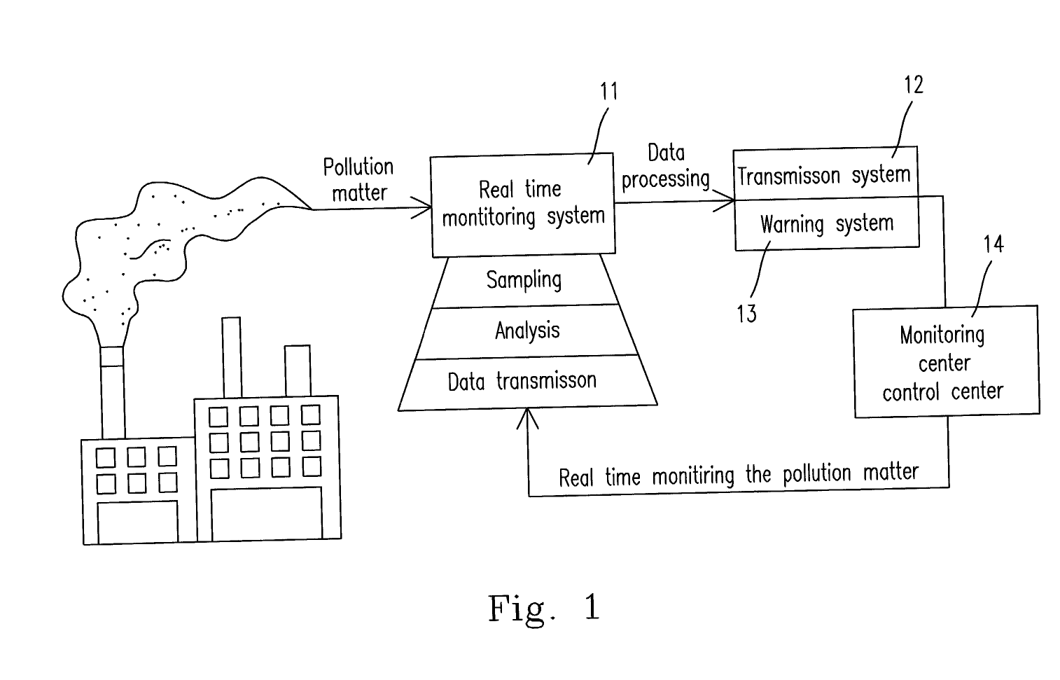

The present invention is a real time monitoring system (RTMS) having a remote transmission system and a warning system. Furthermore, the present invention is an on-site real time monitoring system adapted to be established in a place where a gaseous pollution sample has to be monitored for quickly obtaining and controlling the gaseous pollution sample information. As shown in FIG. 1, a real time monitoring system 11 is connected to a remote transmission system 12, and transmits the real time information to the monitoring center or the control room of laboratory 14 by the transmission system such as network, facsimile or electronic communication for immediately monitoring the distribution and amount of the gaseous pollution sample. Furthermore, when the level of gaseous pollution sample is over a limitation and harms human and environment, a warning system 13 of the real time monitoring system will send out a warning message for achieving the real time monitoring.

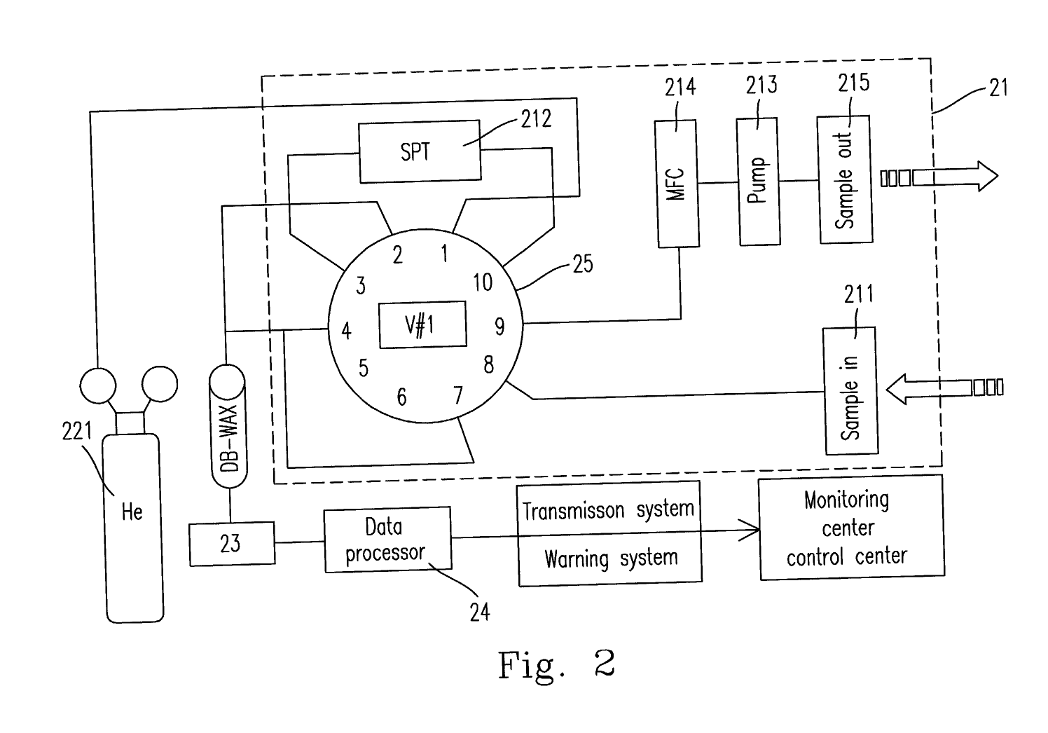

FIG. 2 is a diagram illustrating a real time monitoring system according to a preferred embodiment of the present invention. As shown in FIG. 2, the real time monitoring system for automatically monitoring a gaseous pollution sample in environment includes a sample preprocess apparatus (SPA) 21 for immediately processing the gaseous pollution sample at room temperature, wherein the gaseous pollution sample comprises a polar and a non-polar compounds, a sample separation apparatus 22 for separating the gaseous pollution sample, a sample analysis apparatus 23 for analyzing a target compound of the gaseous pollution sample, and a data processing device 24 for automatically processing an analyzed data of the target compound to achieve the real time monitoring system.

Table 1 shows chemical and physical properties of the target compounds which are the pollution matters in high technology industry park.

TABLE 1
Chemical and Physical Properties of the Target Compounds.

| | | | | Melting | Boiling |
|---|---|---|---|---|---|
| | | MW | Density | point | Point |
| Name | Formula | (g/mole) | (g/cm³) | (° C.) | (° C.) |
| IPA | C₃H₈O | 60 | 0.785 | −86 | 82 |
| Acetone | (CH₃)CO | 58 | 0.79 | −95.4 | 56.2 |
| 2-Butanone | C₄H₈O | 72 | 0.8 | −86.3 | 79.6 |
| PGMEA* | C₆H₁₂O₃ | 132 | 0.957 | \ | 146 |
| Cyclopentanone | C₅H₈O | 84 | 0.95 | −58 | 131 |
| 2-Heptanone | C₇H₁₄O | 114 | 0.82 | −35 | 151.5 |
| Trichloroethylene | CCl₂CHCl | 131.5 | 1.46 | −73 | 86.7 |
| Benzene | C₆H₆ | 78 | 0.88 | 5.5 | 80 |
| Toluene | C₆H₅CH₃ | 92 | 0.87 | −95 | 110.6 |
| Xylene | C₈H10 | 114 | 0.86 | \ | 137 |
| Butyl acetate | C₆H₁₂O₂ | 116 | 0.88 | −77 | 126.3 |

*PGMEA = propylene glycol monomethylethyl acetate

As shown in FIG. 2, the sample preprocessing apparatus 21 further includes an entering position 211 directly connected to ambient for adsorbing the gaseous pollution sample, a pump 213 connected to the entering position for providing a sucking power, a mass flow controller (MFC) 214 for controlling a flow rate of the gaseous pollution sample, an exiting position 215 for outputting the gaseous pollution sample, and a sample preconcentration device (SPD) 212 for concentrating the gaseous pollution sample. The environmental gas concentration is too low to be analyzed, so the preconcentration treatment is required for proceeding qualitative and quantitative analysis. The adsorbent used in the sample preconcentration device 212 is a graphitized carbon black and a carbon molecular sieve.

In addition, for an on-site real time monitoring, a liquid carbon oxide is used to be a cooling agent instead of liquid nitrogen. Thus, the sample preconcentration device is able to adsorb and concentrate the gaseous pollution sample at room temperature.

The separation apparatus 22 includes a capillary column such as DB-Wax for separating the gaseous pollution sample, a column oven for providing temperature changing, and a carrying gas 221, i.e. helium, for carrying the gaseous pollution sample. The sample analysis apparatus 23 includes a gas chromatography for qualitative analysis and a detector for quantitative analysis. The detector can be a flame ionized detector (FID) for detecting a hydrocarbon, an electronic capture detector for detecting a halogen compound, or a mass spectrophotometer for determining the target compound. Therefore, according to the different detectors, the gaseous pollution sample can be efficiently determined.

The operation of the real time monitoring system is described in detail as the following steps:

1. Sampling: The gaseous pollution sample is collected by the entering position. The entering position made of Teflon is directly connected to the pump and opened to ambient air. The pump is connected to a mass flow controller for consistently controlling the sample in. In addition, the mass flow controller also proceeds the adjustment of temperature and pressure of the gaseous pollution sample. The flow rate of the real time monitoring system is 30 ml/min and the holding time is 20 minutes, so the total collecting volume is 600 ml.

2. Sample preprocessing: The target compound concentration in ambient air is about ppbv level which cannot be detected by the conventional equipments, so the preconcentration treatment of the gaseous pollution sample is necessary. The gaseous pollution sample is adsorbed by the adsorbent including the graphitized carbon black and the carbon molecular sieve at room temperature of 30°C. During absorption, the liquid carbon oxide is used as a cooling agent. After finishing sample collection, the gaseous pollution sample is desorbed from the sample preconcentration device by quickly increasing temperature to 350°C. and into the separation apparatus.

3. Separation: The concentrated gaseous pollution sample is separated by a DB-Wax capillary column (60 m ×0.53 mm ×1 μm) at an initial temperature of 40°C. without using cooling agent. Sequentially, the temperature increasing is controlled by program. The carrying gas is helium.

4. Detection: The flame ionized detector is employed to detect the target compound because all of them are hydrocarbons. The qualitative analysis of the target compound is determined by the remaining time of the target compound and the quantitative analysis of that is determined by calculating the peak area of the target compound according to a standard curve.

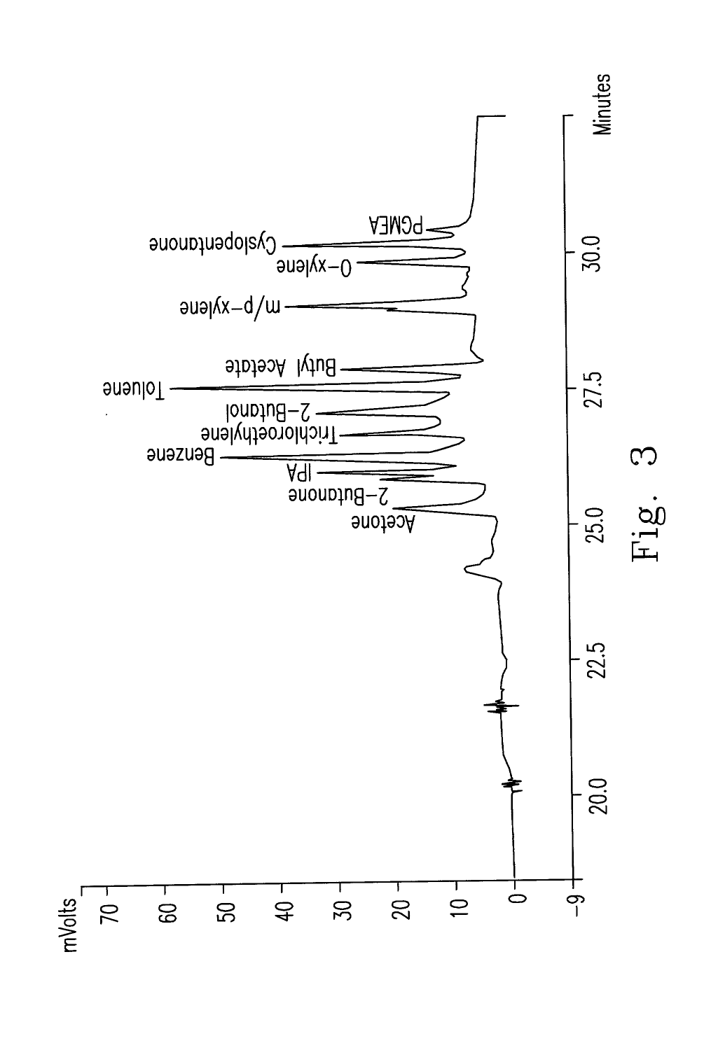

5. Data processing: After analysis, the chromatogram of the target compound is automatically calculated by Saturn View program to do the qualitative and quantitative analysis. Then, the data is transmitted to the monitoring center for checking by the operator. FIG. 3 shows a standard chromatogram of the target compound.

6. QA/QC:

(a) Construction of Standard Curve: The standard curve of the target compound is constructed for determining the amount thereof, and the relative coefficient of the standard curve is larger than 0.995.

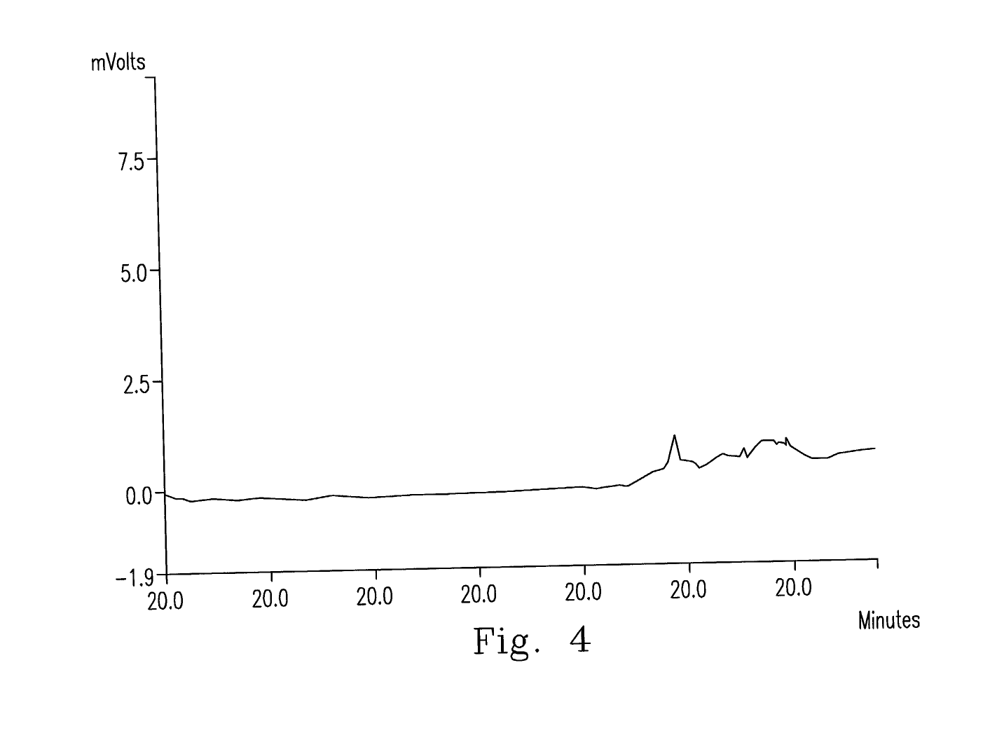

(b) Blank Test: The blank test is used to make sure the system is not contaminated. FIG. 4 shows a chromatogram for a blank test.

(c) System Stability: For assuring the system stability, a standard will be injected into the capillary column per 24 hours via a four-way pneumatic valve. The system will automatically switch valve to inject the standard. If the condition is abnormal, the system will be shut down for checking and repairing. In addition, the standard also provides the correction of quantitative analysis. Table 2 and Table 3 show the evaluation and the correction of the system stability, respectively.

TABLE 2
The evaluation of the system stability

| Days | Day 1 | Day 2 | Day 3 | Day 4 | Day 5 | Average |
|---|---|---|---|---|---|---|
| Sensitivity | 142212 | 149567 | 146712 | 138652 | 140701 | 143568 |
| Standard | 0.991 | 1.042 | 1.022 | 0.966 | 0.980 | — |
| deviation | | | | | | |

TABLE 3
The correction of the system stability

| | Standard | | | | | |
|---|---|---|---|---|---|---|
| Days | curve | Day 1 | Day 2 | Day 3 | Day 4 | Day 5 |
| Sensitivity | 128252 | 142212 | 149567 | 146712 | 138652 | 140701 |
| Correction | 1 | 1.109 | 1.166 | 1.144 | 1.081 | 1.097 |
| value | | | | | | |

7. Parameters of equipment analysis:

TABLE 4
Parameters of the sample preconcentration device

| Temp. (0° C.) | Hold Time(min) | Total Time (min) |
|---|---|---|
| 30 | 20 | 20 |
| 350 | 1 | 21 |
| 360 | 36 | 57 |

The capillary column type is DB-Wax ((60 m ×0.53 mm ×1 μm) with a column flow of 4 ml/min at 40°C. The parameters of column oven in the sample separation apparatus is shown in Table 5.

TABLE 5
Parameters of column oven in the sample separation apparatus

| | Flow | | |
|---|---|---|---|
| Temp. (0° C.) | Rate (° C./min) | Hold Time (min) | Total Time (min) |
| 40 | 2 | 10.5 | 20.5 |
| 57 | 4 | 0 | 24.7 |
| 100 | 15 | 1 | 28.6 |
| 145 | 5 | 0 | 37.6 |
| 190 | 16 | 15.5 | 55.9 |

The operation temperature of the flame ionized detector is 250°C.

The real time monitoring system according to the present invention is applied to monitor the gaseous pollution sample in high technology industry park for 5 days. As shown in Table 6, the target compounds includes acetone, IPA, benzene, toluene, m,p-xylene, o-xylene, cyclopentanone and PGMEA.

TABLE 6
Practical determined data of the target compound for 5 days in high technology
industry park by the real time monitoring system according to the present invention.

| | | | | | | | Cyclopen- | |
|---|---|---|---|---|---|---|---|---|
| | Acetone | IPA | Benzene | Toluene | m,p-xylene | o-xylene | tanone | PGMEA |
| Average | 19.13 | 3.27 | 8.20 | 11.44 | 1.52 | 1.28 | 0.35 | 0.33 |
| Standard | 26.72 | 1.65 | 10.46 | 14.63 | 2.48 | 1.54 | 0.55 | 0.90 |
| deviation | | | | | | | | |
| Maximum | 155.63 | 10.81 | 49.51 | 140.23 | 12.28 | 7.67 | 3.04 | 6.05 |
| Time for | Day 2 | Day 1 | Day 2 | Day 4 | Day 5 | Day 1 | Day 2 | Day 4 |
| Maximum | 17:00 | 22:00 | 18:00 | 10:00 | 15:00 | 7:00 | 11:00 | 20:00 |
| Minimum | 1.5 | ND | 0.20 | ND | ND | ND | ND | ND |
| Time for | Day 3 | Day 2 | Day 3 | * | * | * | * | * |
| Minimum | 00:00 | 04:00 | 22:00 | | | | | |

Unit: ppbv
ND = Not Detected
* = Not detected at multiple time points

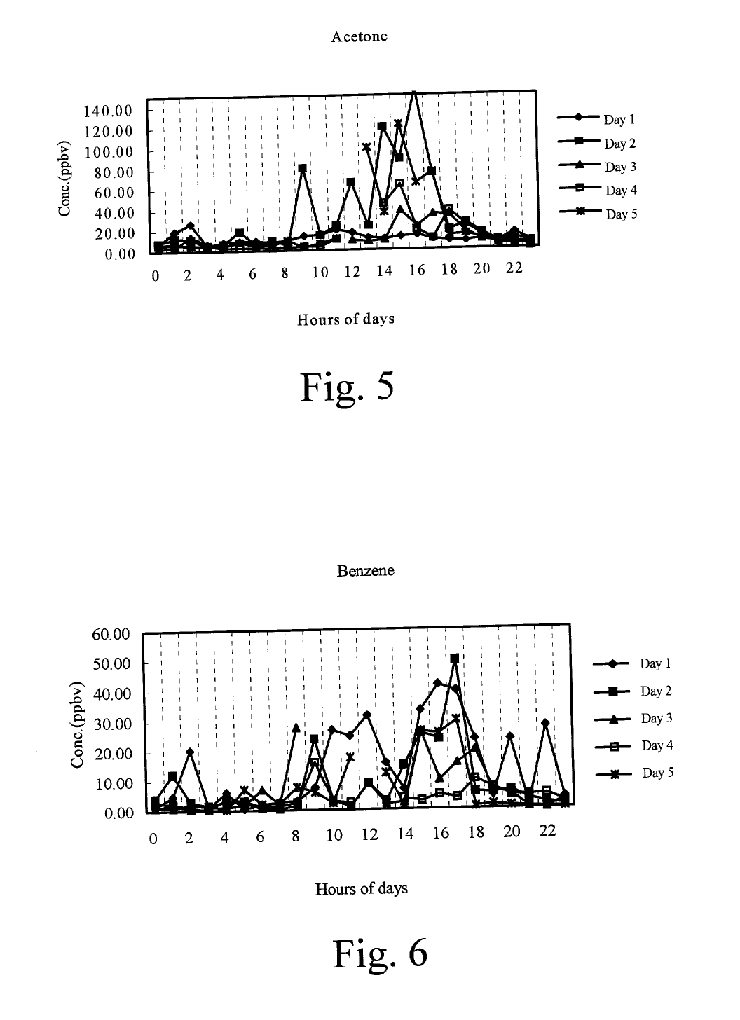

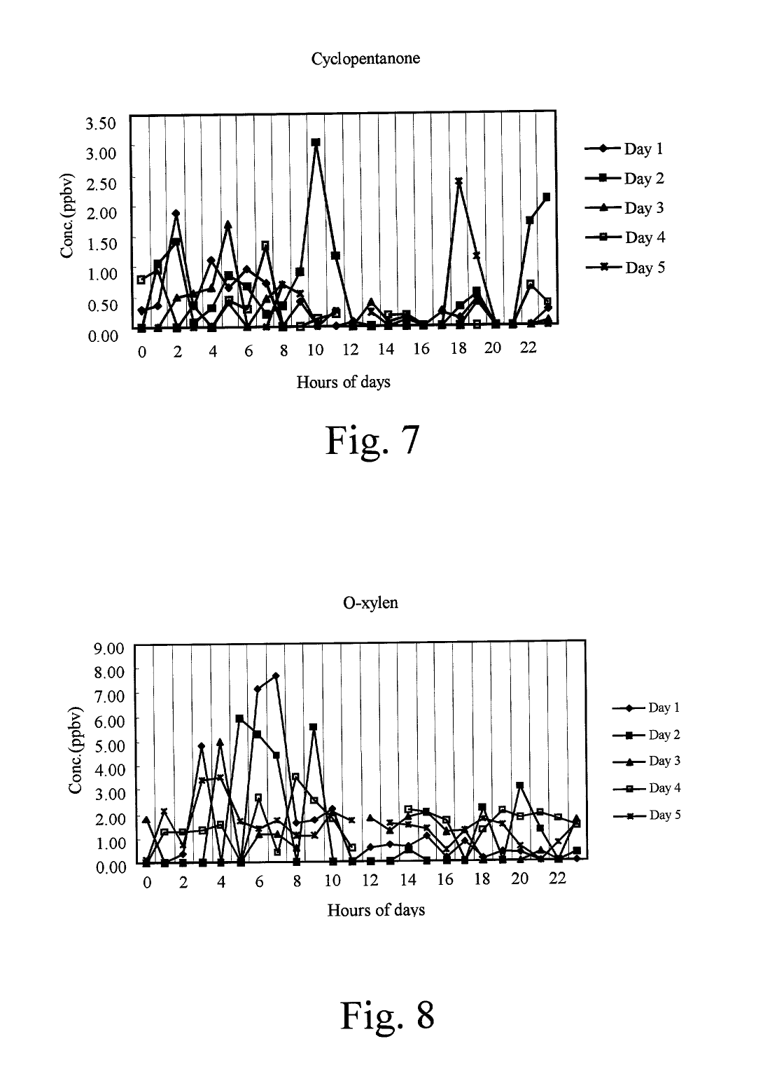

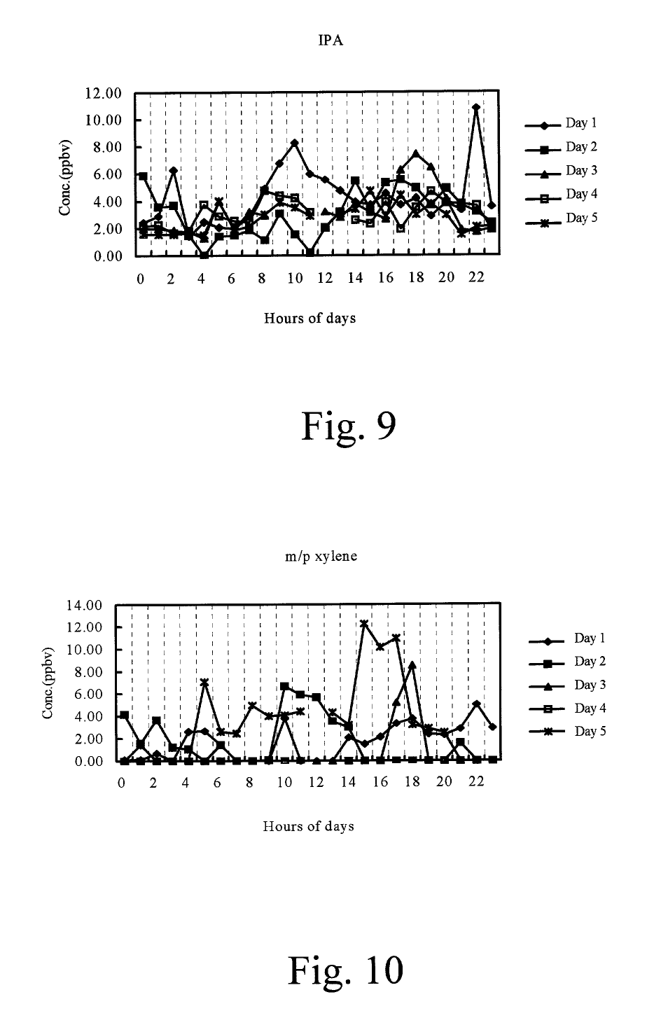

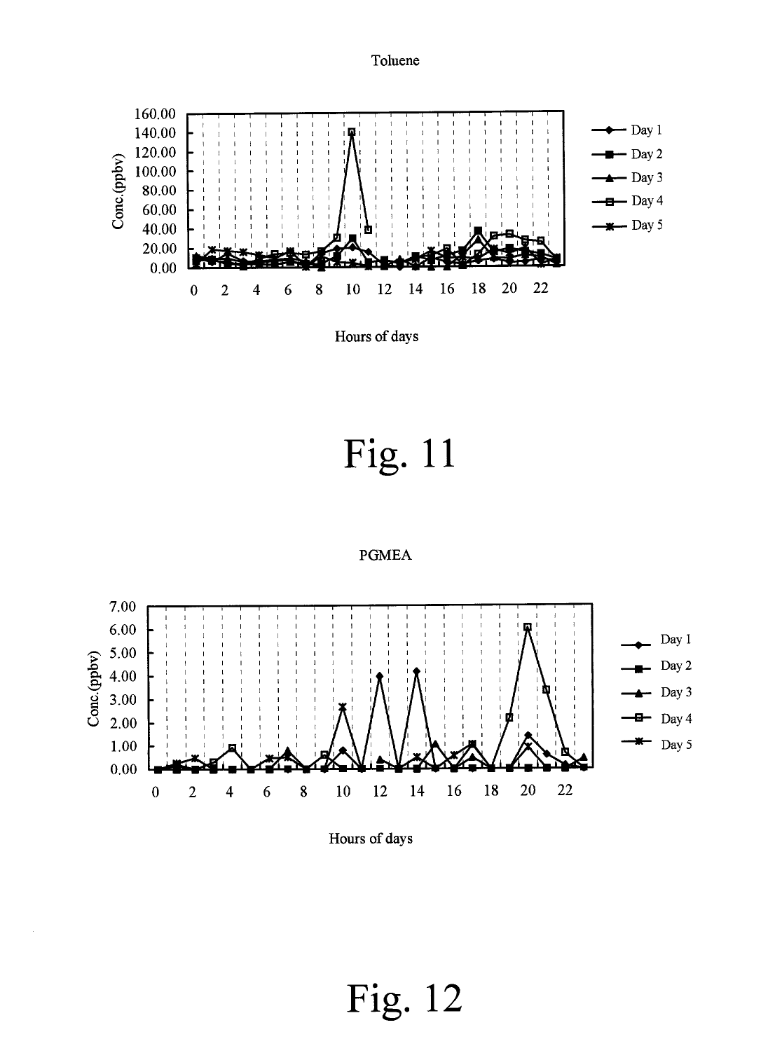

FIGS. 5-12 are plots illustrating a real time monitoring system to monitor acetone, benzene, cyclopentanone, o-xylene, IPA, m,p-xylene, toluene and propylene glycol monomethylethyl acetate (PGMEA) per hour for 5 days respectively according to the present invention.

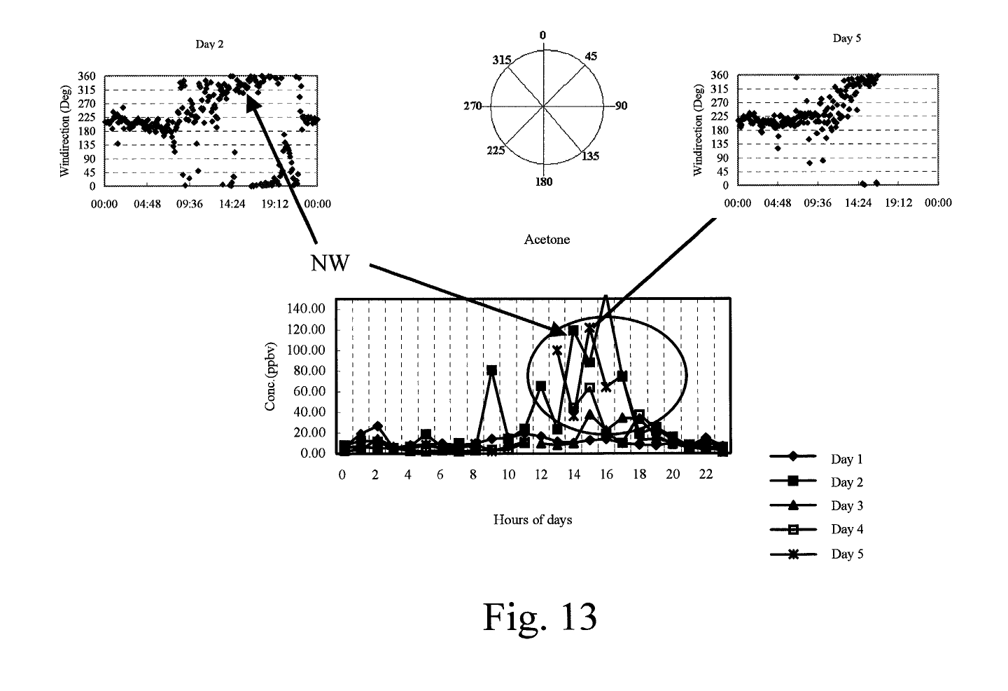

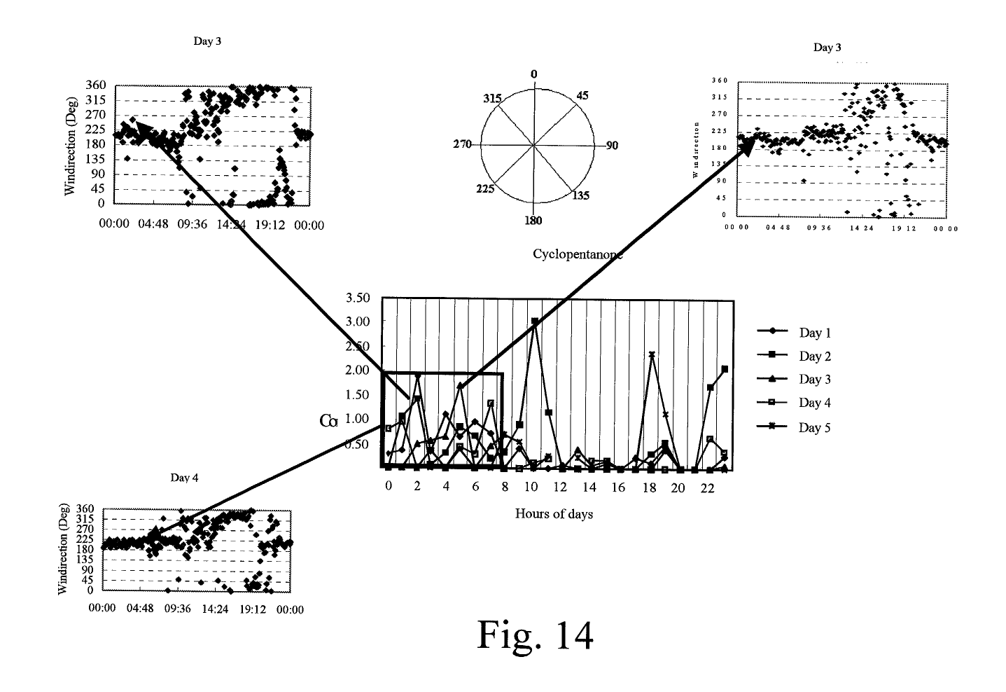

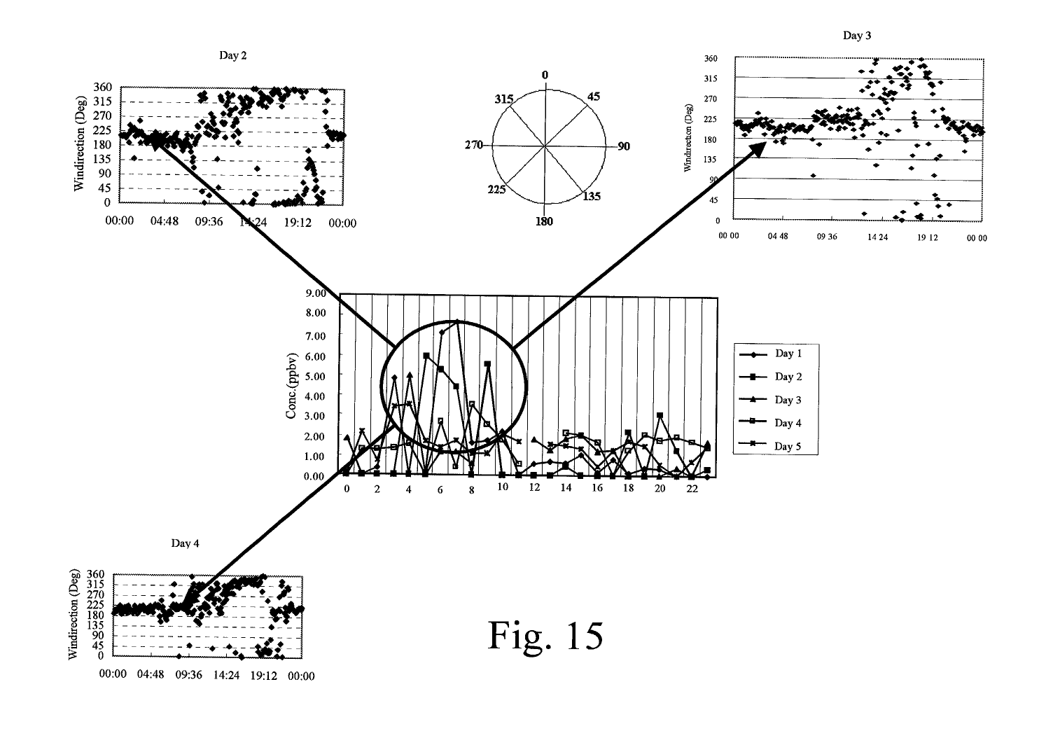

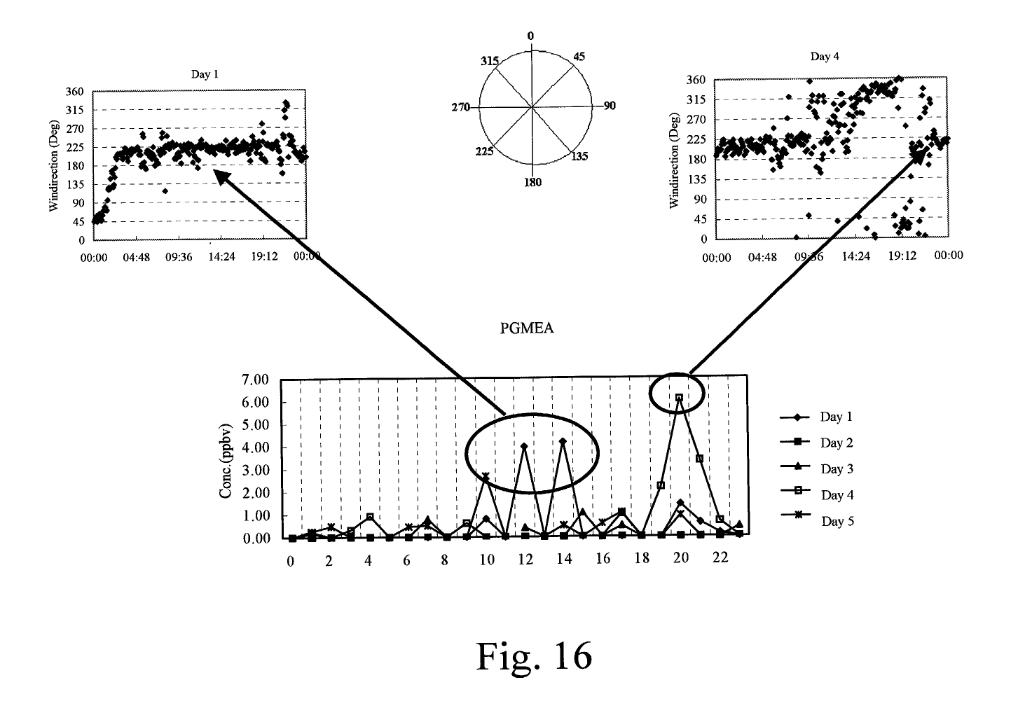

FIGS. 13-16 are diagrams illustrating a real time monitoring system to monitor acetone, cyclopentanone, o-xylene and propylene glycol monomethylethyl acetate (PGMEA) per hour for 5 days with the wind direction according to the present invention.

Accordingly, the real time monitoring system of the present invention applied to an on-site real time monitoring has the following advantages:

1. The present invention directly applies a laboratory gas analysis technology to the work field, so the real time monitoring system has high mobility and high efficiency for monitoring the environmental air quality.

2. The real time monitoring system according to the present invention is an automatic sampling, separating, analyzing and data processing system, so it can reduce labor- and time-consumptions.

3. The operator can handle the on-site real time monitoring system by remote controlling.

4. The real time monitoring system according to the present invention can reduce the consumption of cooling agent.

5. The real time monitoring system according to the preferred embodiment of the present invention proceeds 24 hour continuous monitoring and collects the sample for 20 minutes per hour. Because the holding time for sample collection is 20 minutes, the representative of the sample is increased. In addition, the 24 sample data per day can provide sufficient air quality data related to time.

6. The real time monitoring system according to the present invention will combine the analyzed data with the information of wind direction and wind speed to provide the air quality data related to location.

While the invention has been described in terms of what are presently considered to be the most practical and preferred embodiments, it is to be understood that the invention need not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A real time monitoring system for automatically monitoring a gaseous pollution sample in environment, comprising:
a sample preprocess apparatus (SPA) for immediately processing said gaseous pollution sample at room temperature, wherein said gaseous pollution sample comprises a polar and a non-polar compounds;
a sample separation apparatus for separating said gaseous pollution sample;
a sample analysis apparatus for analyzing a target compound of said gaseous pollution sample; and
a data processing device for automatically processing an analyzed data of said target compound to achieve said real time monitoring system.

2. The system according to claim 1 further connecting to a remote transmission system for immediately transmitting said analyzed data to a user, wherein said remote transmission system including a far-end remote controlling system and a warning system.

3. The system according to claim 1 further comprising a systemically automatic adjusting device employing a standard sample inside a capillary column to adjust said analysis apparatus for maintaining the stability of said real time monitoring system.

4. The system according to claim 3, wherein said systemically automatic adjusting device comprises a pneumatic valve used for injecting said standard sample inside said capillary column into said sample preprocessing apparatus for adjusting said real time monitoring system.

5. The system according to claim 4, wherein said pneumatic valve is a four-way pneumatic valve.

6. The system according to claim 1, wherein said real time monitoring system is a real time on-site monitoring system.

7. The system according to claim 1, wherein said sample preprocessing apparatus comprises:
an entering position directly connected to ambient air for adsorbing said gaseous pollution sample;
a pump connected to said entering position for providing a sucking power;
a mass flow controller for controlling a flow rate of said gaseous pollution sample;
an exiting position for outputting said gaseous pollution sample; and
a sample preconcentration device (SPT) for concentrating said gaseous pollution sample.

8. The system according to claim 7, wherein said sample preconcentration device employs an adsorbent for adsorbing said target compound.

9. The system according to claim 7, wherein said sample preconcentration device further employs a cooling agent for enhancing the adsorption of said target compound.

10. The system according to claim 9, wherein said cooling agent is liquid carbon dioxide.

11. The system according to claim 1, wherein said separation apparatus comprises:
a capillary column for separating said gaseous pollution sample;
a column oven for providing temperature changing; and
a carrying gas for carrying said gaseous pollution sample.

12. The system according to claim 11, wherein said carrying gas is Helium.

13. The system according to claim 1, wherein said sample analysis apparatus employs a gas chromatograph and a detector for proceeding qualitative and quantitative analysis.

14. The system according to claim 13, wherein said detector is one selected from a group consisting of a flame ionized detector (FID), an electronic capture detector, and a mass spectrophotometer.

15. The system according to claim 1, wherein said target compound is one selected from a group consisting of acetone, 2-butanone, isopropyl alcohol (IPA), benzene, trichloroethylene, 2-butanol, toluene, butyl acetate, m,p-xylene, o-xylene, cyclopentanone, propylene glycol monomethylethyl acetate (PGMEA) and the mixture thereof.

16. A real time monitoring system for automatically monitoring a gaseous pollution sample in environment, comprising:
a sample preprocess apparatus (SPA) for immediately processing said gaseous pollution sample at room temperature, said sample preprocess apparatus comprising a systemically automatic adjusting device for adjusting and stabilizing said real time monitoring system, wherein said gaseous pollution sample comprising a polar and a non-polar compounds;
a sample separation apparatus for separating said gaseous pollution sample;
a sample analysis apparatus for analyzing a target compound of said gaseous pollution sample; and
a data processing device for automatically processing an analyzed data of said target compound to achieve said real time monitoring system.

17. A real time monitoring system for automatically monitoring a gaseous pollution sample in environment, comprising:
a sample preprocess apparatus (SPA) for immediately processing said gaseous pollution sample at room temperature, said sample preprocess apparatus comprising a sample preconcentration device for immediately concentrating said gaseous pollution sample, wherein said gaseous pollution sample comprises a polar and a non-polar compounds;
a sample separation apparatus for separating said gaseous pollution sample;
a sample analysis apparatus for analyzing a target compound of said gaseous pollution sample; and
a data processing device for automatically processing an analyzed data of said target compound to achieve said real time monitoring system.
